(19) United States
(12) Patent Application Publication
(10) Pub. No.: US 2023/0177551 A1
(43) Pub. Date: Jun. 8, 2023

(54) LOYALTY DELIVERED SALES ESTIMATION SYSTEM AND METHOD

(71) Applicant: CAPILLARY PTE. LTD., Singapore (SG)

(72) Inventors: Pranoot Prakash Hatwar, Maharashtra (IN); Biswa Gourav Singh, Odisha (IN); Pravanjan Chaudhury, Karnataka (IN); Rishabh Ojha, Karnataka (IN); Subrat Kumar Panda, Punjab (IN); Jyotiska Bhattacharjee, Karnataka (IN)

(21) Appl. No.: 18/075,039

(22) Filed: Dec. 5, 2022

(30) Foreign Application Priority Data
Dec. 7, 2021 (IN) 202141056798

(51) Int. Cl. G06Q 30/0211; G06Q 30/0202; G06Q 30/0204; G06Q 30/0207

(52) U.S. Cl. CPC G06Q 30/0211; G06Q 30/0202; G06Q 30/0204; G06Q 30/0236

(57) ABSTRACT

A loyalty delivered sales estimation system uses a database with customer and retail store data including customer transactional and demographics data together with store retail and promotional data. The system estimates loyalty sales information related to one or more loyalty programs implemented by the retail store. A loyalty delivered sales (LDS) estimation module analyzes the customer and store data to identify at least two statistically similar customer groups: a first group with customers that have redeemed benefits of a loyalty programs and a second group with customers that are not enrolled with the loyalty program. The LDS estimation module computes a divergence value between the first and second customer groups over a period of time and estimates a loyalty delivered sales metrics corresponding to the one or more loyalty programs using the at least one computed divergence value.

### PRIORITY STATEMENT

The present application claims priority under 35 U.S.C. §119 to Indian patent application number 202141056798 filed Dec. 7, 2021, the entire contents of which are hereby incorporated herein by reference.

### FIELD

The present invention relates to a system and method for evaluation of loyalty programs employed by organizations such as for retail environments and, more particularly, to techniques related to determination of loyalty delivered sales from such loyalty programs.

### BACKGROUND

Many organizations and brands spend substantial amount of money and resources every year on customer loyalty programs to retain their best and rewarding customers. While loyalty programs are rewarding, it may be a difficult task for brands to figure out the spends and return on investments (ROI) they get from their loyalty programs. Identifying the impact of the program over topline sales can help loyalty program service providers identify the value they have added to the corresponding businesses revenue and device mechanisms to improve the metrics.

Moreover, it may be advantageous to develop techniques to assess the true impact of loyalty programs on business sales of the organizations. Such techniques may be helpful to evaluate the loyalty program and the organizations and service providers can design the program according to the impact it creates for the businesses. Moreover, such metrics may be used to identify the actions businesses could take to drive their sales corresponding to loyalty programs.

### SUMMARY

The following summary is illustrative only and is not intended to be in any way limiting. In addition to the illustrative aspects, example embodiments, and features described, further aspects, example embodiments, and features will become apparent by reference to the drawings and the following detailed description.

Briefly, according to an example embodiment, a loyalty delivered sales estimation system is provided. The loyalty delivered sales estimation system includes a database configured to store customer data and store data corresponding to a retail store. The customer data comprises at least one of customer transactional data and customer demographics data for one or more customers of the retail store and the store data comprises retail and promotional data of the retail store. The loyalty delivered sales estimation system includes a processor coupled to the database and configured to estimate loyalty sales information related to one or more loyalty programs implemented by the retail store. The processor further includes a loyalty delivered sales (LDS) estimation module configured to access the customer data and the store data from the database. The LDS estimation module is configured to analyze the customer data to identify at least two statistically similar customer groups based on transactions of the one or more customers of the retail store. The at least two statistically similar customer groups include a first customer group with customers that have redeemed benefits of the one or more loyalty programs and a second customer group with the one or more customers that are not enrolled with the one or more loyalty programs. The LDS estimation module is configured to compute at least one divergence value between the first and second customer groups over a period of time and estimate one or more loyalty delivered sales metrics corresponding to the one or more loyalty programs using the at least one computed divergence value. The loyalty delivered sales estimation system also includes a display module configured to present the one or more loyalty delivered sales metrics and the loyalty sales information to a user of the loyalty delivered sales estimation system.

In another embodiment, a method for managing a loyalty delivered sales estimation metric is provided. The method includes storing, by a loyalty delivered sales estimation system, customer data and store data corresponding to a retail store in a database. The customer data includes at least one of customer transactional data and customer demographics data for one or more customers of the retail store and the store data comprises retail and promotional data of the retail store. The method includes estimating, by the loyalty delivered sales estimation system, loyalty sales information related to one or more loyalty programs implemented by the retail store and accessing, by the loyalty delivered sales estimation system, the customer data, and the store data from the database to analyze the customer data to identify at least two statistically similar customer groups based on transactions of the one or more customers of the retail store. The at least two statistically similar customer groups include a first customer group with customers that have redeemed benefits of the one or more loyalty programs and a second customer group with the one or more customers that are not enrolled with the one or more loyalty programs. The method further includes computing, by the loyalty delivered sales estimation system, at least one divergence value between the first and second customer groups over a period of time and estimating, by the loyalty delivered sales estimation system, one or more loyalty delivered sales metrics corresponding to the one or more loyalty programs using the at least one computed divergence value. The method also includes presenting, by the loyalty delivered sales estimation system, the one or more loyalty delivered sales metrics and the loyalty sales information to a user of the loyalty delivered sales estimation system.

### BRIEF DESCRIPTION OF THE FIGURES

These and other features, aspects, and advantages of the example embodiments will become better understood when the following detailed description is read with reference to the accompanying drawings in which like characters represent like parts throughout the drawings, wherein:

FIG. 1 is a block diagram illustrating a loyalty delivered sales (LDS) estimation system employed by an organization, according to an example embodiment;

FIG. 2 and FIG. 3 are example illustrations of a process used by the LDS estimation system of FIG. 1;

FIG. 4 illustrates an example process for estimation of divergence using the LDS estimation system of FIG. 1;

FIG. 5 illustrates a method for managing a loyalty delivered sales estimation metric; and

FIG. 6 is a block diagram of an embodiment of a computing device in which the modules of the LDS estimation system, described herein, are implemented.

### DETAILED DESCRIPTION OF EXAMPLE EMBODIMENTS

The drawings are to be regarded as being schematic representations and elements illustrated in the drawings are not necessarily shown to scale. Rather, the various elements are represented such that their function and general purpose become apparent to a person skilled in the art. Any connection or coupling between functional blocks, devices, components, or other physical or functional units shown in the drawings or described herein may also be implemented by an indirect connection or coupling. A coupling between components may also be established over a wireless connection. Functional blocks may be implemented in hardware, firmware, software, or a combination thereof.

Various example embodiments will now be described more fully with reference to the accompanying drawings in which only some example embodiments are shown. Specific structural and functional details disclosed herein are merely representative for purposes of describing example embodiments. Example embodiments, however, may be embodied in many alternate forms and should not be construed as limited to only the example embodiments set forth herein.

Accordingly, while example embodiments are capable of various modifications and alternative forms, example embodiments are shown by way of example in the drawings and will herein be described in detail. It should be understood, however, that there is no intent to limit example embodiments to the particular forms disclosed. On the contrary, example embodiments are to cover all modifications, equivalents, and alternatives thereof. Like numbers refer to like elements throughout the description of the figures.

Before discussing example embodiments in more detail, it is noted that some example embodiments are described as processes or methods depicted as flowcharts. Although the flowcharts describe the operations as sequential processes, many of the operations may be performed in parallel, concurrently, or simultaneously. In addition, the order of operations may be re-arranged. The processes may be terminated when their operations are completed but may also have additional steps not included in the figure. The processes may correspond to methods, functions, procedures, subroutines, subprograms, etc.

Specific structural and functional details disclosed herein are merely representative for purposes of describing example embodiments. Inventive concepts may, however, be embodied in many alternate forms and should not be construed as limited to only the example embodiments set forth herein.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of example embodiments. As used herein, the term “and/or,” includes any and all combinations of one or more of the associated listed items. The phrase “at least one of” has the same meaning as “and/or”.

Further, although the terms first, second, etc. may be used herein to describe various elements, components, regions, layers and/or sections, it should be understood that these elements, components, regions, layers and/or sections should not be limited by these terms. These terms are used only to distinguish one element, component, region, layer, or section from another region, layer, or section. Thus, a first element, component, region, layer, or section discussed below could be termed a second element, component, region, layer, or section without departing from the scope of inventive concepts.

Spatial and functional relationships between elements (for example, between modules) are described using various terms, including “connected,” “engaged,” “interfaced,” and “coupled.” Unless explicitly described as being “direct,” when a relationship between first and second elements is described in the above disclosure, that relationship encompasses a direct relationship where no other intervening elements are present between the first and second elements, and also an indirect relationship where one or more intervening elements are present (either spatially or functionally) between the first and second elements. In contrast, when an element is referred to as being “directly” connected, engaged, interfaced, or coupled to another element, there are no intervening elements present. Other words used to describe the relationship between elements should be interpreted in a like fashion (e.g., “between,” versus “directly between,” “adjacent,” versus “directly adjacent,” etc.).

The terminology used herein is for the purpose of describing particular example embodiments only and is not intended to be limiting. As used herein, the singular forms “a,” “an,” and “the,” are intended to include the plural forms as well, unless the context clearly indicates otherwise. As used herein, the terms “and/or” and “at least one of” include any and all combinations of one or more of the associated listed items. It will be further understood that the terms “comprises,” “comprising,” “includes,” and/or “including,” when used herein, specify the presence of stated features, integers, steps, operations, elements, and/or components, but do not preclude the presence or addition of one or more other features, integers, steps, operations, elements, components, and/or groups thereof.

It should also be noted that in some alternative implementations, the functions/acts noted may occur out of the order noted in the figures. For example, two figures shown in succession may in fact be executed substantially concurrently or may sometimes be executed in the reverse order, depending upon the functionality/acts involved.

Unless otherwise defined, all terms (including technical and scientific terms) used herein have the same meaning as commonly understood by one of ordinary skill in the art to which example embodiments belong. It will be further understood that terms, e.g., those defined in commonly used dictionaries, should be interpreted as having a meaning that is consistent with their meaning in the context of the relevant art and will not be interpreted in an idealized or overly formal sense unless expressly so defined herein.

Spatially relative terms, such as “beneath”, “below”, “lower”, “above”, “upper”, and the like, may be used herein for ease of description to describe one element or feature’s relationship to another element(s) or feature(s) as illustrated in the figures. It will be understood that the spatially relative terms are intended to encompass different orientations of the device in use or operation in ‘addition to the orientation depicted in the figures. For example, if the device in the figures is turned over, elements described as “below”, or “beneath” other elements or features would then be oriented “above” the other elements or features. Thus, term such as “below” may encompass both an orientation of above and below. The device may be otherwise oriented (rotated 90 degrees or at other orientations) and the spatially relative descriptors used herein are interpreted accordingly.

Portions of the example embodiments and corresponding detailed description may be presented in terms of software, or algorithms and symbolic representations of operation on data bits within a computer memory. These descriptions and representations are the ones by which those of ordinary skill in the art effectively convey the substance of their work to others of ordinary skill in the art. An algorithm, as the term is used here, and as it is used generally, is conceived to be a self-consistent sequence of steps leading to a desired result. The steps are those requiring physical manipulations of physical quantities. Usually, though not necessarily, these quantities take the form of optical, electrical, or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

At least one example embodiment is generally directed to techniques for evaluation of loyalty programs employed by organizations. In particular, the embodiments disclose techniques relating to determination of loyalty delivered sales from such loyalty programs over predetermined periods of time.

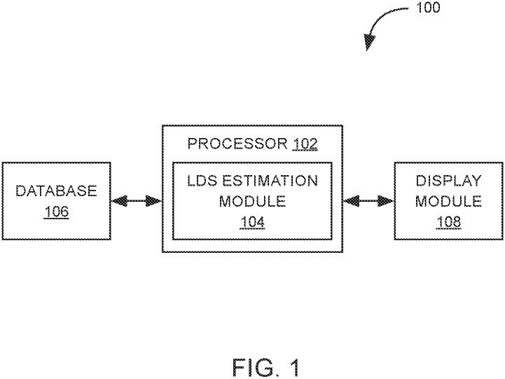

Turning to the drawings, FIG. 1 is a block diagram illustrating one embodiment of a loyalty delivered sales (LDS) estimation system 100 that may be employed by an organization. In some embodiments, the LDS estimation system 100 may be coupled to a CRM application of the organization. The system 100 includes a processor 102, a memory 106 and an output 108. The processor 102 is communicatively coupled to the memory 106 to access data such as sales data, customer information and so forth. The processor 102 further includes a loyalty delivered sales (LDS) estimation module 104 configured to estimate loyalty delivered sales (LDS) and related information corresponding to one or more loyalty programs utilized by the organization to retain customers. Such information may be made available to a user of the system 100 via the output 108.

In this example, the (LDS) estimation module 104 employs techniques to determine two statistically similar groups and observe their divergence over time and use the divergence values to determine parameters such as a percentage (%) return of investment (ROI) of a loyalty program delivered over topline sales of the organization/enterprise. In some examples, the statistical similar groups are arrived at by choosing a time-period where a group of customers becomes first time point redeemers for their purchases and finds a substantially similar group with customers who have never redeemed the points till date. The similarity of two groups is determined based on a modified k nearest neighbor algorithm. Moreover, the similarity of the two groups is validated using statistical comparisons.

The generated metrics from the LDS estimation system 100 are utilized for gauging the value a certain loyalty program imparts and helps the organizations make decisions which potentially should increase such metrics. Example metrics generated by the LDS estimation system 100 include loyalty Driven Sales % that is representative of percentage of topline sales driven by loyalty program over a period, loyalty driven sales representative of the sales value driven by the loyalty program over a period of time and divergence that helps to identify incremental sales contributed by people enrolled in loyalty program when compared to their similar counterparts who are not part of loyalty program.

In this embodiment, the LDS estimation system 100 is configured to estimate the value delivered sales via identification and creation of similar groups of customers, estimation of divergence and estimation of divergence with respect to the top line sales and total sales.

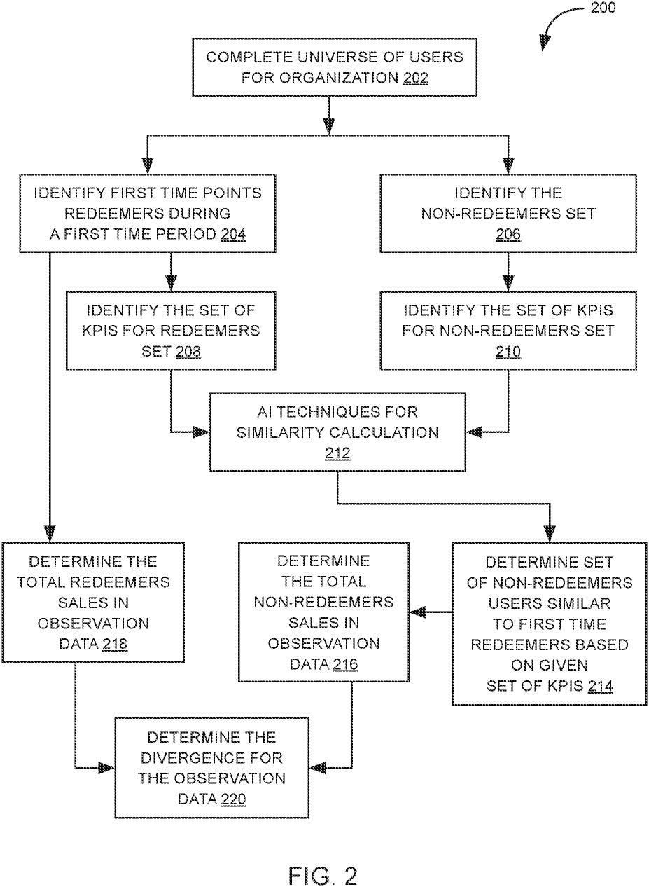

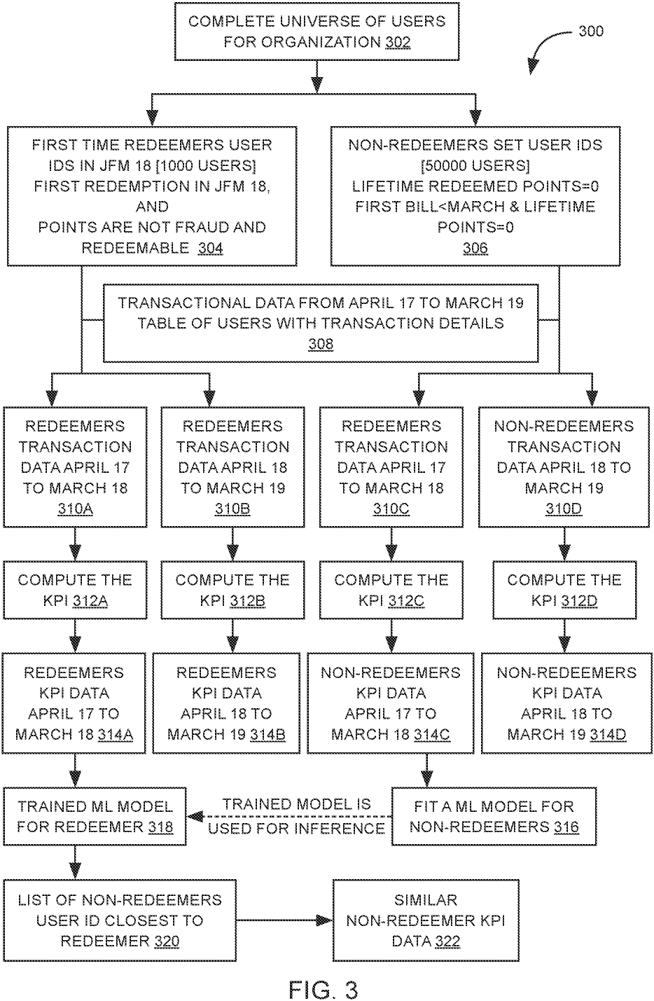

FIG. 2 and FIG. 3 are example illustrations 200 and 300 of the process used by the LDS estimation system 100 of FIG. 1. The LDS estimation module 104 employs statistical techniques to identify similar groups of customers to identify the impact of the loyalty program offered by the organization. In one example, the LDS estimation module 104 is configured to analyze future transactional behavior of a group of customers e.g., group A to get information about how the behavior of users changed post first-time redemption, and the future transactional behavior of another group B may provide information regarding a picture of the behavior of group A users if they never redeemed in their lifetime.

The steps for calculating 1 year LDS% value by the LDS estimation module 104 are illustrated in the process 200 of FIG. 2. In this embodiment, two groups A and B are selected from the universe of the customers in an organization. Here, the group A includes set of user IDs selected from all the users that satisfy criteria such as first redemption in a quarter (represented here byJFM18) and the users that have redeemed points that are not fraud and redeemable and so forth. Moreover, users are selected such that each of the users have first time bill date at least once before a defined period such as March 18. Moreover, the group B is set of users that are selected from all the users with certain criteria such as those who have not redeemed their points, users those have total lifetime points is a non-zero value, users that have their first-time bill date at least once before the defined period March ’18.

In this embodiment, the group A includes a set of users who have redeemed for the first time in JFM ‘18 redeemers set and similarly group B includes users that are of the non-redeemers set. For these user IDs in groups A and B all the transactions from 1 year before 31st March ‘18 from 1st April ‘17 to 31st March ‘18 is accessed and are used to find a subset of group B that is substantially similar to group A in their transactional behavior in the past 1 year.

In some examples, a plurality of key performance indicators (KPIs) is used by the LDS estimation module 104 to measure the statistical similarity between these groups. Such KPIs may include, but are not limited to, number of visits by users, average spend per visit, total bill and campaign contacted/responded. Such KPIs are estimated for a stipulated period such as on the past 1 year data of both the groups.

In one example, let us assume group A (i.e., redeemers Group) includes 100 users and group B (i.e., non-Redeemers group) includes 500 users. The LDS estimation module 104 employs machine learning methodologies such as approximate nearest neighbor algorithm to identify about 100 unique users from group B that are statistically similar to 100 users from group A.

Further, the LDS estimation module 104 is configured to build a model using group B user’s data and such model is used for group A users for obtaining the inferences. Here, the inference result determines nearest neighbors for inferred group A user ID. These nearest neighbors may be uniquely identified using process such as described below.

In an embodiment, LDS estimation module 104 is configured to select unique nearest users from group B. The LDS estimation module 104 is configured to create an empty list (herein referred to as subset_b) where nearest users from group B for each group A user are appended while iterating over group A. Further, while iterating over all redeemers in the group A, the first nearest neighbor user ID of group B is added to subset_b if that user ID is not present in list subset_b already. If it is detected to be present, the second nearest user ID is added to subset and if even the second nearest user is present in subset_b the algorithm checks for third and so on. Herein, the process is iterated over all the users of group A and 100 similar unique users are selected based on KPIs from group B.

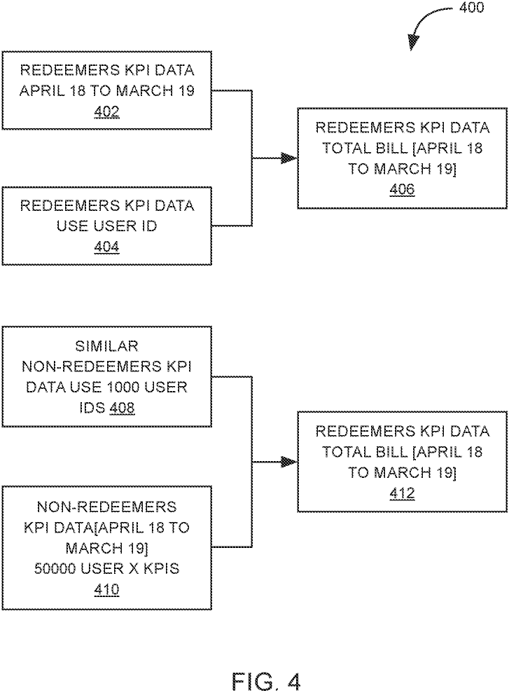

FIG. 4 illustrates an example process 400 for estimation of divergence using the system 100 of FIG. 1. In this embodiment, once the two identical groups are created as described with reference to FIG. 2 or FIG. 3, all the transactions for user IDs in group A and subset_b are fetched for next 1 year (e.g., after 31st March ‘18 i.e., from 1st April ‘18 to 31st March ‘19) and this is used to find annual divergence on several KPIs for group A and subset_b over a period of 2 years. In this example, the KPIs used are number of visits, average spend per visit, total bill to find similar groups. Here, the divergence on several KPIs helps identifying the change in behavior of group A (redeemers) and subset b (similar non-redeemers to group A).

As used herein, the term “divergence” refers to incremental sales of group A with respect to subset_b. In this example, the divergence is estimated using the below relationship: Divergence = (total salesgroup A - total salessubset_b) / total salesgroup A

The divergence for a good loyalty program in past 1 period should be close to 0 that indicates the user behavior of group A and subset_b to be highly similar before first time redemption by users of group A.

In some examples, key parameters such as loyalty delivered sales (LDS), LDS percentage are estimated by the LDS estimation module 104 of the system 100 of FIG. 1. As used herein the term “Loyalty Delivered sales” is estimated using the following relationship Loyalty Delivered Sales = Divergence x Total Redeemer Sales

Moreover, LDS percentage is the delivered sales over topline and is estimated using the following relationship: Loyalty Delivered Sales % = Loyalty Delivered Sales / Total Sales

As will be appreciated by one skilled in the art, the above-described framework facilitates an organization with a holistic view of the sales delivered because of loyalty program (LDS) along with providing key insights such as what proportion of the topline sales is these sales (LDS%).

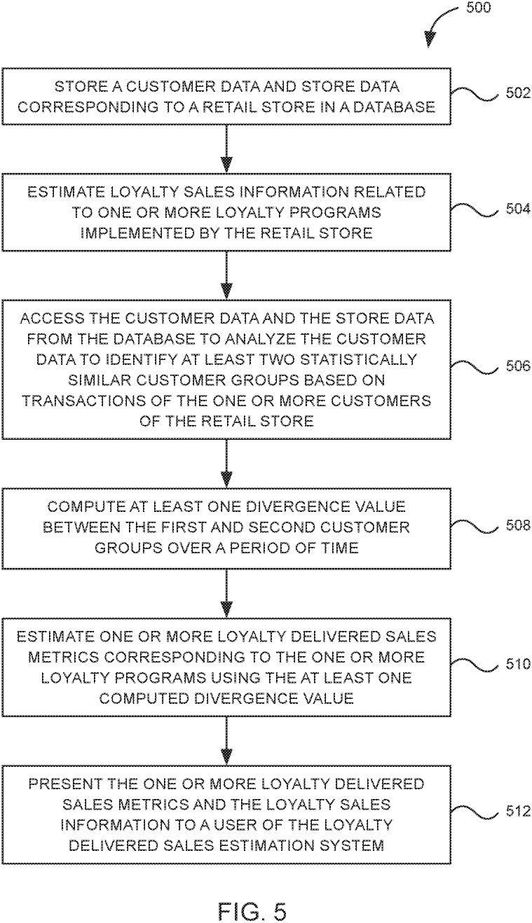

FIG. 5 is a flow chart (500) illustrating a method for managing a loyalty delivered sales estimation metric. The operations (502-512) are handled by the LDS estimation module (104).

At 502, the method includes storing the customer data and the store data corresponding to the retail store in the database (106). The customer data includes at least one of customer transactional data and customer demographics data for one or more customers of the retail store and the store data includes retail and promotional data of the retail store.

At 504, the method includes estimating loyalty sales information related to one or more loyalty programs implemented by the retail store. At 506, the method includes accessing the customer data and the store data from the database (106) to analyze the customer data to identify at least two statistically similar customer groups based on transactions of the one or more customers of the retail store. The at least two statistically similar customer groups include a first customer group with customers that have redeemed benefits of the one or more loyalty programs and a second customer group with the one or more customers that are not enrolled with the one or more loyalty programs.

At 508, the method includes computing the at least one divergence value between the first and second customer groups over a period of time. At 510, the method includes estimating the one or more loyalty delivered sales metrics corresponding to the one or more loyalty programs using the at least one computed divergence value. At S512, the method includes presenting the one or more loyalty delivered sales metrics and the loyalty sales information to a user of the loyalty delivered sales estimation system.

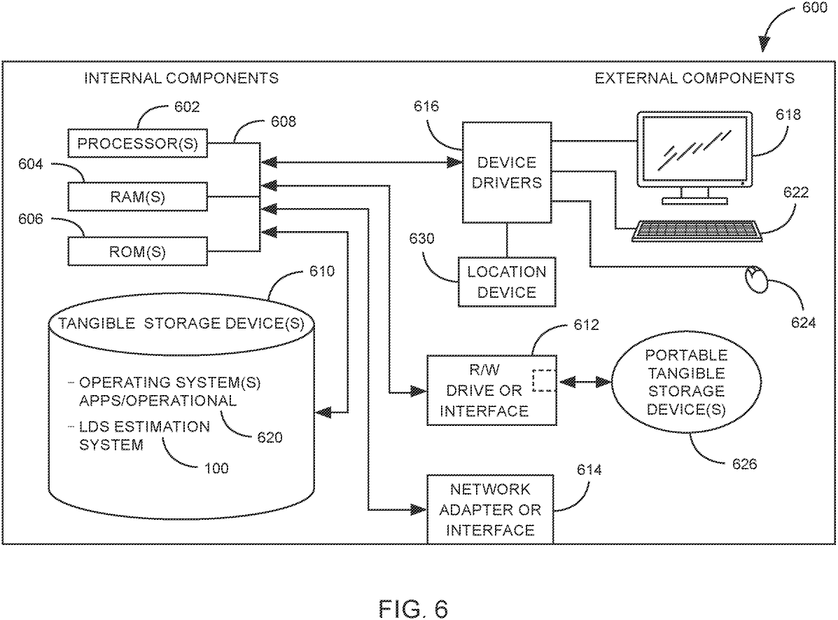

The modules of the LDS estimation system 100 described herein are implemented in computing devices. One example of a computing device 600 is described below in FIG. 6. The computing device includes one or more processor 602, one or more computer-readable RAMs 604 and one or more computer-readable ROMs 606 on one or more buses 608. Further, computing device 600 includes a tangible storage device 610 that may be used to execute operating systems 620 and the LDS estimation system 100. The various modules of the LDS estimation system 100 may be stored in tangible storage device 610. Both, the operating system 620 and the system 100 are executed by processor 602 via one or more respective RAMs 604 (which typically include cache memory). The execution of the operating system 620 and/or the system 100 by the processor 602, configures the processor 602 as a special purpose processor configured to carry out the functionalities of the operation system 620 and/or the LDS estimation system 100 as described above.

Examples of storage devices 610 include semiconductor storage devices such as ROM, EPROM, flash memory or any other computer-readable tangible storage device that may store a computer program and digital information.

Computing device also includes a R/W drive or interface 614 to read from and write to one or more portable computer-readable tangible storage devices 628 such as a CD-ROM, DVD, memory stick or semiconductor storage device. Further, network adapters or interfaces 612 such as a TCP/IP adapter cards, wireless Wi-Fi interface cards, or 3G or 4G wireless interface cards or other wired or wireless communication links are also included in computing device.

In one example embodiment, the LDS estimation system 100 may be stored in tangible storage device 610 and may be downloaded from an external computer via a network (for example, the Internet, a local area network or other, wide area network) and network adapter or interface 612.

Computing device further includes device drivers 616 to interface with input and output devices. The input and output devices may include a computer display monitor 618, a keyboard 624, a keypad, a touch screen, a computer mouse 626, and/or some other suitable input device.

It will be understood by those within the art that, in general, terms used herein, are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present.

For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations. In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations).

While only certain features of several embodiments have been illustrated, and described herein, many modifications and changes will occur to those skilled in the art. It is, therefore, to be understood that the appended claims are intended to cover all such modifications and changes as fall within the true spirit of inventive concepts.

The aforementioned description is merely illustrative in nature and is in no way intended to limit the disclosure, its application, or uses. The broad teachings of the disclosure may be implemented in a variety of forms. Therefore, while this disclosure includes particular examples, the true scope of the disclosure should not be so limited since other modifications will become apparent upon a study of the drawings, the specification. It should be understood that one or more steps within a method may be executed in different order (or concurrently) without altering the principles of the present disclosure. Further, although each of the example embodiments is described above as having certain features, any one or more of those features described with respect to any example embodiment of the disclosure may be implemented in and/or combined with features of any of the other embodiments, even if that combination is not explicitly described. In other words, the described example embodiments are not mutually exclusive, and permutations of one or more example embodiments with one another remain within the scope of this disclosure.

The example embodiment or each example embodiment should not be understood as a limiting/restrictive of inventive concepts. Rather, numerous variations and modifications are possible in the context of the present disclosure, in particular those variants and combinations which may be inferred by the person skilled in the art with regard to achieving the object for example by combination or modification of individual features or elements or method steps that are described in connection with the general or specific part of the description and/or the drawings, and, by way of combinable features, lead to a new subject matter or to new method steps or sequences of method steps, including insofar as they concern production, testing and operating methods. Further, elements and/or features of different example embodiments may be combined with each other and/or substituted for each other within the scope of this disclosure.

Still further, any one of the above-described and other example features of example embodiments may be embodied in the form of an apparatus, method, system, computer program, tangible computer readable medium and tangible computer program product. For example, of the aforementioned methods may be embodied in the form of a system or device, including, but not limited to, any of the structure for performing the methodology illustrated in the drawings.

In this application, including the definitions below, the term ‘module’ or the term ‘controller’ may be replaced with the term ‘circuit.’ The term ‘module’ may refer to, be part of, or include processor hardware (shared, dedicated, or group) that executes code and memory hardware (shared, dedicated, or group) that stores code executed by the processor hardware.

The module may include one or more interface circuits. In some examples, the interface circuits may include wired or wireless interfaces that are connected to a local area network (LAN), the Internet, a wide area network (WAN), or combinations thereof. The functionality of any given module of the present disclosure may be distributed among multiple modules that are connected via interface circuits. For example, multiple modules may allow load balancing. In a further example, a server (also known as remote, or cloud) module may accomplish some functionality on behalf of a client module.

Further, at least one example embodiment relates to a non-transitory computer-readable storage medium comprising electronically readable control information (e.g., computer-readable instructions) stored thereon, configured such that when the storage medium is used in a controller of a magnetic resonance device, at least one example embodiment of the method is carried out.

Even further, any of the aforementioned methods may be embodied in the form of a program. The program may be stored on a non-transitory computer readable medium, such that when run on a computer device (e.g., a processor), cause the computer-device to perform any one of the aforementioned methods. Thus, the non-transitory, tangible computer readable medium is adapted to store information and is adapted to interact with a data processing facility or computer device to execute the program of any of the above-mentioned embodiments and/or to perform the method of any of the above-mentioned embodiments.

The computer readable medium or storage medium may be a built-in medium installed inside a computer device main body or a removable medium arranged so that it may be separated from the computer device main body. The term computer-readable medium, as used herein, does not encompass transitory electrical or electromagnetic signals propagating through a medium (such as on a carrier wave), the term computer-readable medium is therefore considered tangible and non-transitory. Non-limiting examples of the non-transitory computer-readable medium include, but are not limited to, rewriteable non-volatile memory devices (including, for example flash memory devices, erasable programmable read-only memory devices, or a mask read-only memory devices), volatile memory devices (including, for example static random access memory devices or a dynamic random access memory devices), magnetic storage media (including, for example an analog or digital magnetic tape or a hard disk drive), and optical storage media (including, for example a CD, a DVD, or a Blu-ray Disc). Examples of the media with a built-in rewriteable non-volatile memory, include but are not limited to memory cards, and media with a built-in ROM, including but not limited to ROM cassettes, etc. Furthermore, various information regarding stored images, for example, property information, may be stored in any other form, or it may be provided in other ways.

The term code, as used above, may include software, firmware, and/or microcode, and may refer to programs, routines, functions, classes, data structures, and/or objects. Shared processor hardware encompasses a single microprocessor that executes some or all code from multiple modules. Group processor hardware encompasses a microprocessor that, in combination with additional microprocessors, executes some or all code from one or more modules. References to multiple microprocessors encompass multiple microprocessors on discrete dies, multiple microprocessors on a single die, multiple cores of a single microprocessor, multiple threads of a single microprocessor, or a combination of the above.

Shared memory hardware encompasses a single memory device that stores some or all code from multiple modules. Group memory hardware encompasses a memory device that, in combination with other memory devices, stores some or all code from one or more modules.

The term memory hardware is a subset of the term computer-readable medium. The term computer-readable medium, as used herein, does not encompass transitory electrical or electromagnetic signals propagating through a medium (such as on a carrier wave), the term computer-readable medium is therefore considered tangible and non-transitory. Non-limiting examples of the non-transitory computer-readable medium include, but are not limited to, rewriteable non-volatile memory devices (including, for example flash memory devices, erasable programmable read-only memory devices, or a mask read-only memory devices), volatile memory devices (including, for example static random access memory devices or a dynamic random access memory devices), magnetic storage media (including, for example an analog or digital magnetic tape or a hard disk drive), and optical storage media (including, for example a CD, a DVD, or a Blu-ray Disc). Examples of the media with a built-in rewriteable non-volatile memory, include but are not limited to memory cards, and media with a built-in ROM, including but not limited to ROM cassettes, etc. Furthermore, various information regarding stored images, for example, property information, may be stored in any other form, or it may be provided in other ways.

The apparatuses and methods described in this application may be partially or fully implemented by a special purpose computer created by configuring a general-purpose computer to execute one or more particular functions embodied in computer programs. The functional blocks and flowchart elements described above serve as software specifications, which may be translated into the computer programs by the routine work of a skilled technician or programmer.

The computer programs include processor-executable instructions that are stored on at least one non-transitory computer-readable medium. The computer programs may also include or rely on stored data. The computer programs may encompass a basic input/output system (BIOS) that interacts with hardware of the special purpose computer, device drivers that interact with particular devices of the special purpose computer, one or more operating systems, user applications, background services, background applications, etc.

The computer programs may include: (i) descriptive text to be parsed, such as HTML (hypertext markup language) or XML (extensible markup language), (ii) assembly code, (iii) object code generated from source code by a compiler, (iv) source code for execution by an interpreter, (v) source code for compilation and execution by a just-in-time compiler, etc. As examples only, source code may be written using syntax from languages including C, C++, C#, Objective-C, Haskell, Go, SQL, R, Lisp, Java®, Fortran, Perl, Pascal, Curl, OCaml, Javascript®, HTML5, Ada, ASP (active server pages), PHP, Scala, Eiffel, Smalltalk, Erlang, Ruby, Flash®, Visual Basic®, Lua, and Python®.

What is claimed is:

1. A loyalty delivered sales estimation system, comprising:
a database configured to store customer data and store data corresponding to a retail store, wherein the customer data comprises at least one of customer transactional data and customer demographics data for one or more customers of the retail store and the store data comprises retail and promotional data of the retail store,
a processor coupled to the database and configured to estimate loyalty sales information related to one or more loyalty programs implemented by the retail store, wherein the processor comprises:
a loyalty delivered sales (LDS) estimation module configured to access the customer data and the store data from the database and to:
analyze the customer data to identify at least two statistically similar customer groups based on transactions of the one or more customers of the retail store, wherein the at least two statistically similar customer groups comprise a first customer group with customers that have redeemed benefits of the one or more loyalty programs and a second customer group with the one or more customers that are not enrolled with the one or more loyalty programs; compute at least one divergence value between the first and second customer groups over a period of time; and
estimate one or more loyalty delivered sales metrics corresponding to the one or more loyalty programs using the at least one computed divergence value; and
a display module configured to present the one or more loyalty delivered sales metrics and the loyalty sales information to a user of the loyalty delivered sales estimation system.

2. The loyalty delivered sales estimation system as claimed in claim 1, wherein the LDS estimation module is further configured to:
identify the first customer group having one or more customers that are first time loyalty point redeemers for their purchases;
determine the second customer group having one or more customers with substantially similar transactional behaviour as the first customer group; and
determine statistical similarity between the first and second customer groups based on a modified k nearest neighbour technique, a machine learning technique, or combinations thereof.

3. The loyalty delivered sales estimation system as claimed in claim 2, wherein the LDS estimation module is configured to measure the statistical similarity based upon a plurality of key performance indicators (KPIs).

4. The loyalty delivered sales estimation system as claimed in claim 3, wherein the plurality of KPIs comprise a number of visits by a customer, an average spend per visit, a total bill and campaign contacted, campaign responded over a period of time, or combinations thereof.

5. The loyalty delivered sales estimation system as claimed in claim 2, wherein the LDS estimation module is configured to build an analytics model with data corresponding to the second customer group, and wherein the analytics model is used to predict transactional behaviours of the first customer group.

6. The loyalty delivered sales estimation system as claimed in claim 1, wherein the LDS estimation module is configured to estimate the one or more loyalty delivered sales metrics using the at least one divergence value and a total redeemer sales value.

7. The loyalty delivered sales estimation system as claimed in claim 5, wherein the LDS estimation module is further configured to compute an LDS percentage using a loyalty delivered sales value and a total sales value.

8. The loyalty delivered sales estimation system as claimed in claim 1, wherein the one or more loyalty delivered sales metrics are representative of a percentage return of investment (ROI) of the one or more loyalty programs delivered over a sale of the retail store.

9. The loyalty delivered sales estimation system as claimed in claim 1, wherein the LDS estimation module is configured to utilize the at least one divergence value to identify incremental sales contributed by the first customer group compared with the second customer group.

10. The loyalty delivered sales estimation system as claimed in claim 1, wherein the LDS estimation module is further configured to:
analyze future transactional behaviour of the first customer group to identify the transactional changes of customers post first time points redemption of the customers; and
analyze future transactional behavior of the second customer group to identify transactional behavior of the first customer group if they never redeemed their loyalty points.

11. A method for managing a loyalty delivered sales estimation metric, comprising:
storing, by a loyalty delivered sales estimation system, customer data and store data corresponding to a retail store in a database, wherein the customer data comprises at least one of customer transactional data and customer demographics data for one or more customers of the retail store and the store data comprises retail and promotional data of the retail store;
estimating, by the loyalty delivered sales estimation system, loyalty sales information related to one or more loyalty programs implemented by the retail store;
accessing, by the loyalty delivered sales estimation system, the customer data and the store data from the database to analyze the customer data to identify at least two statistically similar customer groups based on transactions of the one or more customers of the retail store, wherein the at least two statistically similar customer groups comprise a first customer group with customers that have redeemed benefits of the one or more loyalty programs and a second customer group with the one or more customers that are not enrolled with the one or more loyalty programs;
computing, by the loyalty delivered sales estimation system, at least one divergence value between the first and second customer groups over a period of time,
estimating, by the loyalty delivered sales estimation system, one or more loyalty delivered sales metrics corresponding to the one or more loyalty programs using the at least one computed divergence value; and
presenting, by the loyalty delivered sales estimation system, the one or more loyalty delivered sales metrics and the loyalty sales information to a user of the loyalty delivered sales estimation system.

12. The method as claimed in claim 11, wherein the method further comprises:
identifying, by the loyalty delivered sales estimation system, the first customer group having one or more customers that are first time loyalty point redeemers for their purchases;
determining, by the loyalty delivered sales estimation system, the second customer group having one or more customers with substantially similar transactional behaviour as the first customer group; and
determining, by the loyalty delivered sales estimation system, statistical similarity between the first and second customer groups based on a modified k nearest neighbour technique, a machine learning technique, or combinations thereof.

13. The method as claimed in claim 12, wherein the method further comprises measuring, by the loyalty delivered sales estimation system, the statistical similarity based upon a plurality of key performance indicators (KPIs).

14. The method as claimed in claim 13, wherein the plurality of KPIs comprise a number of visits by a customer, an average spend per visit, a total bill and campaign contacted, campaign responded over a period of time, or combinations thereof.

15. The method as claimed in claim 12, wherein the method further comprises building, by the loyalty delivered sales estimation system, an analytics model with data corresponding to the second customer group, and wherein the analytics model is used to predict transactional behaviours of the first customer group.

16. The method as claimed in claim 11, wherein the method further comprises estimating, by the loyalty delivered sales estimation system, the one or more loyalty delivered sales metrics using the at least one divergence value and a total redeemer sales value.

17. The method as claimed in claim 15, wherein the method further comprises computing, by the loyalty delivered sales estimation system, an LDS percentage using a loyalty delivered sales value and a total sales value.

18. The method as claimed in claim 11, wherein the one or more loyalty delivered sales metrics are representative of a percentage return of investment (ROI) of the one or more loyalty programs delivered over a sale of the retail store,.

19. The method as claimed in claim 11, wherein the method further comprises utilizing, by the loyalty delivered sales estimation system, the at least one divergence value to identify incremental sales contributed by the first customer group compared with the second customer group.

20. The method as claimed in claim 11, wherein the method further comprises:
analyzing, by the loyalty delivered sales estimation system, future transactional behaviour of the first customer group to identify the transactional changes of customers post first time points redemption of the customers; and
analyzing, by the loyalty delivered sales estimation system, future transactional behavior of the second customer group to identify transactional behavior of the first customer group if they never redeemed their loyalty points.
